(19) United States
(12) Patent Application Publication
(10) Pub. No.: US 2011/0299107 A1
(43) Pub. Date: Dec. 8, 2011

(54) IMAGE FORMING APPARATUS AND METHOD OF CONTROLLING THE APPARATUS

(75) Inventors: Masamichi Tanji, Kawasaki-shi (JP); Hiroto Tsujii, Kawasaki-shi (JP)

(73) Assignee: CANON KABUSHIKI KAISHA, Tokyo (JP)

(21) Appl. No.: 13/111,068

(22) Filed: May 19, 2011

(30) Foreign Application Priority Data
Jun. 3, 2010 (JP) 2010-128275

(51) Int. Cl. G06F 15/00

(52) U.S. Cl. 358/1.13

(57) ABSTRACT

When the start of a job is instructed, information indicating the start of the job is transmitted to an external apparatus, and the external apparatus receives and processes the transmitted job in response to the information. If another job is received during that time period, execution of that other job is restricted.

### BACKGROUND OF THE INVENTION

1. Field of the Invention

The present invention relates to technology with which an image forming apparatus and an external apparatus cooperatively perform processing.

2. Description of the Related Art

In recent years, not only is there intense competition in price reduction among small image forming apparatuses, but there is also demand to further miniaturize such apparatuses and provide these apparatuses with more functions. In order for such image forming apparatuses to provide the greatest possible functionality and performance with limited hardware resources, technology has been proposed with which an image forming apparatus and an external apparatus cooperatively perform information processing. As an example of such technology, there is technology with which an image forming apparatus and an external apparatus cooperatively perform information processing and image processing, thereby realizing an advanced function (advanced copy function) that cannot be provided by an image forming apparatus alone. The configuration of an image forming apparatus can be simplified by using, for example, technology disclosed in Japanese Patent Laid-Open No. 8-186677 (D1), and as a result, inexpensive devices can be provided.

According to D1, in order to provide a copy function, an image processing apparatus (MFP) in which a scanner and a printer are integrated and an external apparatus such as a personal computer (PC) are connected to each other, and the PC performs image processing on image data obtained by the MFP. In this way, the PC executes image processing that was performed only by the MFP with a conventional copy function, thereby reducing the hardware resources of the MFP. Further, the PC also performs control of the MFP (the start of reading an original and various settings) in D1.

On the other hand, an advanced copy function (pseudo-copy function) has been proposed with which the above copy function can be instructed using a console unit of an MFP. This is a function of executing, using resources of an external apparatus such as a PC, an advanced copy function that cannot be realized with hardware resources of the MFP, and is technology in which the operation thereof can also be performed by the console unit of the MFP. In this case, a scan driver program for controlling an original reading function of the MFP and a print driver program for controlling a print function thereof are installed in the external apparatus. Upon receipt of a user instruction to start copying, the MFP notifies the external apparatus of that instruction, and the external apparatus executes reading of an original, various image processing, and printing in accordance with the driver programs. At this time, although reading and printing of the original are performed by the MFP, various image processing is executed by the hardware resources of the external apparatus and the driver program. With this technology, even if the MFP has a small memory capacity, image data is accumulated in a memory of the external apparatus, instead of that of the MFP, thereby enabling realization of layout processing and sort processing of multiple pages. Moreover, only the minimum necessary hardware is installed in the MFP, and complicated and high-level image processing/color processing and the like are performed by an image processing program installed in the external apparatus. Accordingly, it is possible to achieve higher performance of the MFP while also achieving the cost reduction thereof.

The advanced copy function described above is constituted by three processes, namely, (1) reading of an original by the MFP, (2) image processing by the PC, and (3) printing by the MFP. However, even while executing such a series of advanced copy processes, the MFP may receive a normal print job from another PC, and may be instructed to perform print processing. Accordingly, there is a problem that, if a print job is received from another PC or the like while executing the above processes (1) and (2), the received print job will be executed before the print job according to the advanced copy function in the above process (3). Specifically, there is a problem that while a user gives an instruction to execute advanced copying in front of the MFP and is awaiting the completion thereof, another print job from a PC may interrupt so that printing thereof is executed, and as a result, the user may be kept waiting a long time until copying is completed.

### SUMMARY OF THE INVENTION

An aspect of the present invention is to eliminate the above-mentioned problems with the conventional technology.

A feature of the present invention is that while executing a job executed cooperatively with an external apparatus, an instruction to start a job other than that job is deferred, thereby preventing a situation in which, for instance, the job that is being executed is kept waiting due to the job that has interrupted that job.

According to an aspect of the present invention, there is provided an image forming apparatus capable of executing a specified copy job in which copy processing is performed cooperatively with an external apparatus, the image forming apparatus comprising: an acceptance unit that accepts an instruction to execute the specified copy job; a reading unit that generates image data by reading an original; a transmission unit that transmits the image data generated by the reading unit to the external apparatus if the acceptance unit has accepted the instruction to execute the specified copy job; a reception unit that receives, from the external apparatus, processed image data obtained by the external apparatus performing processing on the image data transmitted by the transmission unit; a print unit that prints an image on a recording material based on the processed image data that has been received by the reception unit; and a restriction unit that restricts printing of other image data that has been received between when the transmission unit transmits the image data to the external apparatus and when the reception unit receives the processed image data.

Further features and aspects of the present invention will become apparent from the following description of exemplary embodiments, with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the hardware configuration of an image forming apparatus according to a first embodiment.

FIG. 2 depicts a top view of a console unit of the image forming apparatus according to the first embodiment.

FIG. 3 is a sequence diagram describing advanced copying according to the first embodiment.

FIG. 4 is a flowchart describing advanced copy processing performed by the image forming apparatus according to the first embodiment.

FIG. 5 is a flowchart describing control processing performed by the image forming apparatus according to a second embodiment.

FIG. 6 is a flowchart describing processing performed by the image forming apparatus according to the second embodiment when advanced copying and normal copying compete with each other.

FIG. 7 is a flowchart describing control processing performed by the image forming apparatus according to a third embodiment.

FIG. 8 is a flowchart describing control processing performed by the image forming apparatus according to the third embodiment.

FIG. 9 is a flowchart describing control processing performed by the image forming apparatus according to a fourth embodiment.

FIG. 10 is a diagram showing an example of a user inquiry screen according to the fourth embodiment.

FIG. 11 is a diagram showing an example of a printed cover page according to the fourth embodiment.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

### First Embodiment

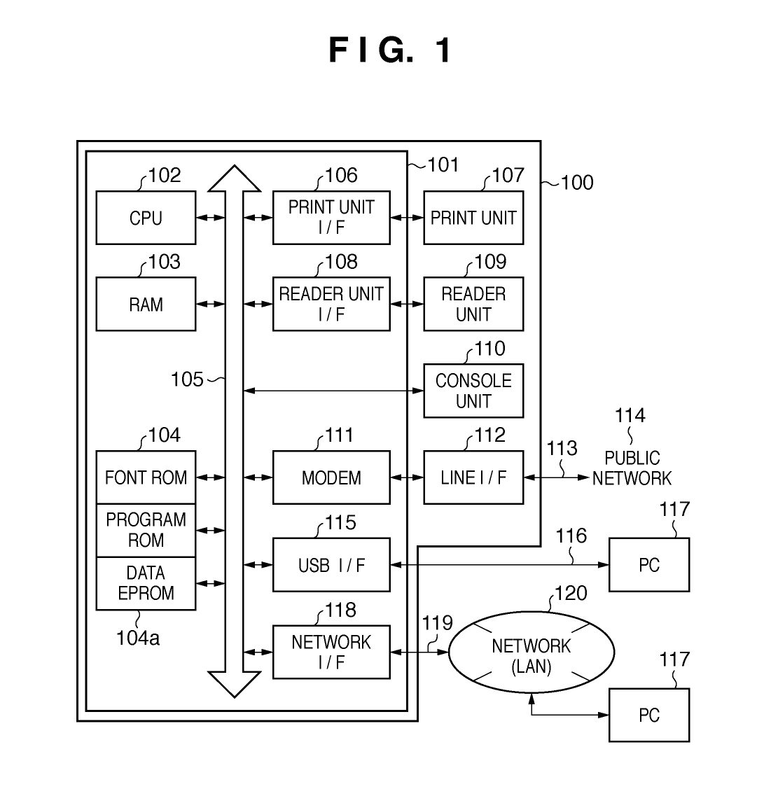

FIG. 1 is a block diagram showing the hardware configuration of an image forming apparatus 100 according to a first embodiment of the present invention. A description is given assuming that the image forming apparatus 100 can communicate with a PC and is a multi-function peripheral that has a scanner function of reading an original, and a print function of printing an image based on print data transmitted from the PC or image data read using the scanner function. Moreover, the image forming apparatus 100 also functions as a facsimile machine.

A controller unit 101 controls a print unit 107, a reader unit 109, a console unit 110, and a line interface 112. The controller unit 101 includes a CPU 102, a RAM 103, a ROM 104, a print unit interface 106, a reader unit interface 108, a MODEM 111, a USB interface 115, and a network interface 118, and the units are connected to each other via a system bus 105. The CPU 102 performs overall control of the blocks in accordance with various control programs. These various control programs are executed by reading the control programs stored in a program ROM of the ROM 104 or by decompressing compressed data stored in a program ROM of the ROM 104 and expanding the resultant data in the RAM 103. Further, a configuration is possible in which the various control programs described above are stored in a compressed or non-compressed state in a hard disk drive (HDD) (not shown), expanded in the RAM 103 when the programs are to be executed, and executed. The network interface (I/F) 118 performs communication processing with a host computer 117 (PC in the diagram) via a network (LAN) 120 or the like. The network interface 118 and the network 120 are connected by a communication cable such as a LAN cable 119. The MODEM 111 is connected to a public network 114 via the line interface (I/F) 112, and performs communication processing with other image forming apparatuses, facsimile machines, telephones, and the like (not shown). The line interface 112 and the public network 114 are ordinarily connected by a telephone line 113, for instance.

The print unit interface (I/F) 106 is an interface that outputs an image signal to the print unit 107 (printer engine). Further, the reader unit interface (I/F) 108 is an interface that inputs, from the reader unit 109 (scanner engine), an image signal read by the reader unit 109. The CPU 102 processes the image signal input from the reader unit interface 108, and outputs the resultant signal to the print unit interface 106 as a print (copy) image signal. In this way, it is possible to realize a copy function for printing an image using the print unit 107 based on the image signal read by the reader unit 109 serving as a scanner. Further, a function, as a PC printer, of printing an image using the print unit 107 based on a print job received from the PC 117 by the USB interface (I/F) 115 or the network interface 118 is also provided. The CPU 102 displays characters and symbols on a display unit of the console unit 110 using font information stored in a font ROM of the ROM 104, and receives instruction information from the console unit 110 that has received a user instruction. Further, apparatus information on the image forming apparatus 100, user telephone directory information, department management information, and the like are stored in an EPROM 104a of a data ROM by the CPU 102, read by the CPU 102 when necessary, and updated when necessary.

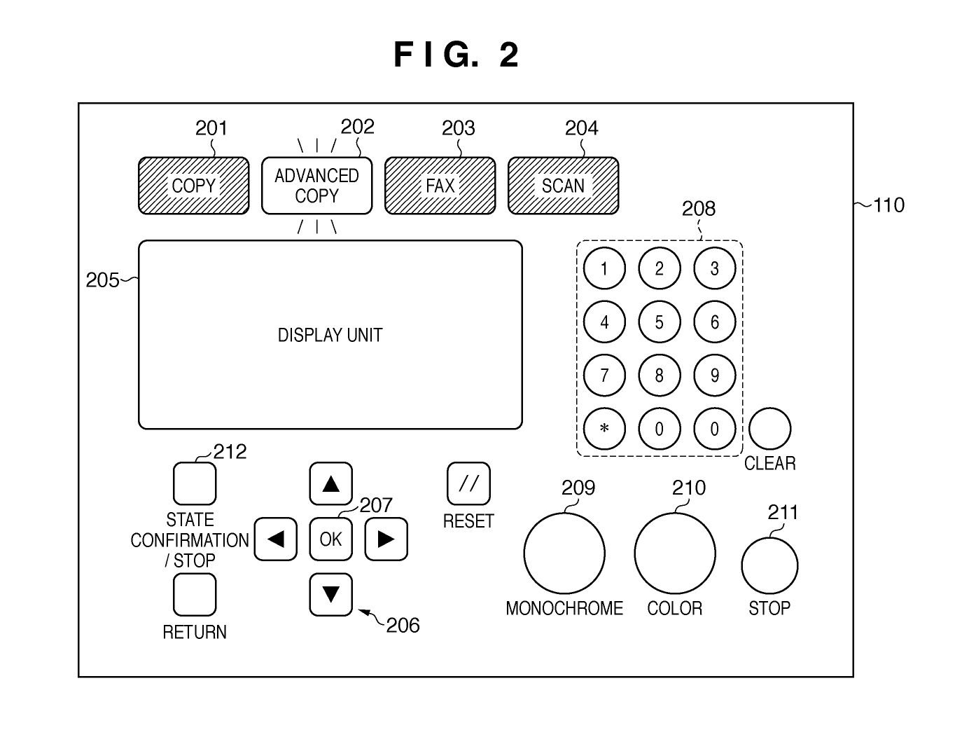

FIG. 2 depicts a top view of the console unit 110 of the image forming apparatus 100 according to the first embodiment. As described above, the image forming apparatus 100 has the copy function achieved by the reader unit 109 and the print unit 107, the scan function achieved by the reader unit 109 and the USB I/F 115, and the facsimile function achieved by the MODEM 111. Moreover, the image forming apparatus 100 also has a function of executing a print job received from the PC 117 via a USB 116 or the network 120. Accordingly, the console unit 110 has function keys (201 to 204) for selecting the functions described above, and a user instructs an operational mode by pressing a button for a function desired to be used.

FIG. 2 shows the state where “advanced copy” has been selected. A display unit 205 for notifying the user of a setting state of the apparatus and the device state of the image forming apparatus 100 is provided. Arrow keys 206 are used for moving a cursor displayed on the display unit 205, and the like. The arrow keys 206 have four buttons for instructing the movement of the cursor in the vertical and horizontal directions. An OK key 207 is disposed in the center of the arrow keys, and has a function of a “determination key” for settings and inquiries. For example, if a copy setting (paper size) is to be changed, a copy screen is displayed by pressing a copy button 201, an item (paper size) to be changed is selected using the arrow keys 206, and the OK key 207 is pressed. Consequently, the current screen transitions to a setting screen in which a paper size can be selected. Then, the cursor is moved to a position for setting a desired paper size using the arrow keys 206 on the setting screen, and the desired paper size can be set by pressing the OK key 207. Further, a ten-key pad 208 is used for inputting the number of copy sets, a telephone number in the facsimile function, and the like.

A monochrome start key 209 and a color start key 210 are provided as keys for instructing the start of copying, scanning, or facsimile. The color start key 210 is provided assuming that a color copy function is provided in the first embodiment. On the other hand, the image forming apparatus 100 that has only a monochrome reading function or a monochrome print function may be provided with only the monochrome start key 209 as a start key. Moreover, in the case of an image forming apparatus that has a function of distinguishing between a color original and a monochrome original when an original is read by the reader unit 109, the start key is not limited to those shown in the diagram, and may be a start key simply for instructing the start of processing. A stop key 211 is a key for instructing the stop of operation of the functions. On the other hand, when operation is to be stopped, the user can select processing to be stopped using a state confirmation/stop key 212 via a screen for confirming the state of processing that is currently being performed by the image forming apparatus, and can stop that processing. In that case as well, the arrow keys 206 and the OK key 207 described above are used for selecting and determining an item.

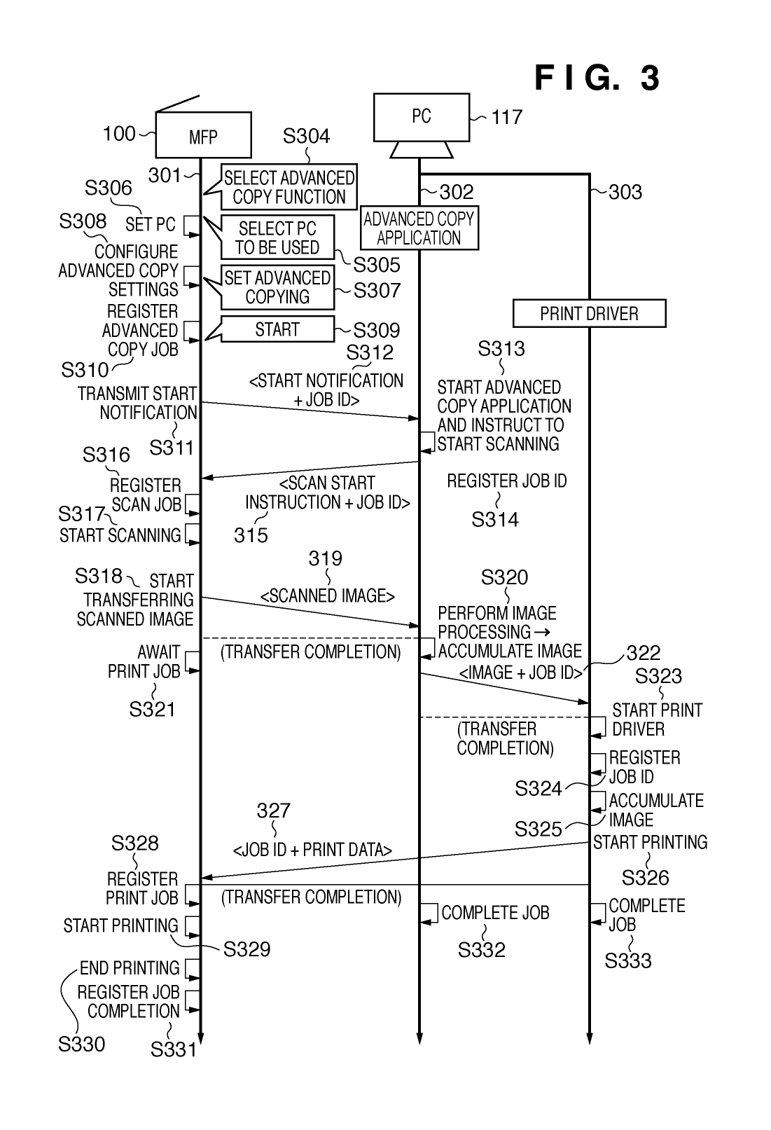

FIG. 3 is a diagram describing advanced copying in an image forming system according to the first embodiment. This advanced copying is a copy function cooperatively performed by the image forming apparatus 100 and the PC 117, and a function that cannot be realized by the image forming apparatus 100 is realized in cooperation with the PC 117 using resources of the PC 117 and the like. FIG. 3 shows a sequence of advanced copy operations realized by causing the image forming apparatus 100 (represented as MFP in the diagram) and the personal computer (PC) 117 serving as an external apparatus to cooperate with each other. Reference numeral 301 shown on the left of FIG. 3 denotes a time axis representing a sequence performed by the image forming apparatus 100, and the two axes 302 and 303 on the right are time axes each representing a sequence performed by the PC 117. The two time axes with regard to the PC 117 respectively denote a time axis 302 representing a processing sequence performed by an advanced copy application for cooperation with the image forming apparatus 100, and a time axis 303 representing a processing sequence performed by a print driver that performs print processing. Note that in the description of FIG. 3, an advanced copying application and a print driver that are compatible with the image forming apparatus 100 are assumed to be installed in advance in the PC 117.

First, it is assumed that the advanced copy function has been selected (an advanced copy key 202 (FIG. 2) on the console unit 110 has been pressed) by the user in step S304. Accordingly, in step S306, the image forming apparatus 100 notifies the user of a screen for selecting a PC for cooperative operation (cooperation). In response to this notification, in step S305, the user selects a PC for cooperation (here, the PC 117). Subsequently, in step S308, necessary settings are accepted from the user prior to performing advanced copying. In this case, if the user executes advanced copying without changing initial settings, this setting processing can be omitted. In step S307, when the image forming apparatus 100 enters a ready state due to the completion of placing of an original and setting of advanced copying by the user, the image forming apparatus 100 awaits a start instruction from the user. When the user instructs the start of advanced copying in step S309 by pressing the color start key 210 or the monochrome start key 209, in step S310, the image forming apparatus 100 gives the job an ID distinguished from a normal copy job as an “advanced copy job”, and registers the job.

Next is a description of the ID of such a job (job ID (identification information)). In the first embodiment, the image forming apparatus 100 is assumed to be able to manage copy jobs, advanced copy jobs, print jobs, scan jobs, fax transmission jobs, FAX reception jobs, and the like. Such jobs are managed using IDs, and stored in the EPROM 104a as data. For example, if a job is a copy job (normal copying), the ID thereof is described in the form of “prefix letters+numbers (nnnnn)” such as “CPnnnnn” (n is a positive integer). On the other hand, IDs of a scan job and a print job are respectively represented by “SNnnnnn” and “PRnnnnn” in the first embodiment.

Advanced copying according to the first embodiment is a copy function cooperatively performed by the PC 117 and the image forming apparatus 100. This advanced copy function is a combination of a “scan function” and a “print function” of the image forming apparatus 100. Accordingly, a job instruction from the PC 117 is executed using the same paths as those of a “scan job” and a “print job”, rather than that of an “advanced copy job”. Thus, the ID of an advanced copy job needs to be a job ID associated with a scan job ID and a print job ID in combination made to realize a function of advanced copying. Accordingly, in the first embodiment, SNennnnn (e is a specific integer) and PRennnnn are used in order to associate an advanced copy job ID with a scan job ID and a print job ID. In this way, if the most significant digit of the integer immediately after the prefix letters is “e” that indicates a scan job or a print job related to advanced copying, it is possible to clearly distinguish such jobs from another normal scan job and another normal print job. Moreover, an ID such as “ACPnnnnn” may be used for an ID of an advanced copy job, in order to distinguish that ID from an ID of a normal copy job. Alternatively, an ID of an advanced copy job may be described and managed as “CPennnnn” obtained by adding “e” that indicates an ID of advanced copying as the most significant digit after the prefix letters of the ID of a normal copy job. Here, if “e” that means an advanced copy job is, for example, “9”, the ID of an advanced copy job is represented by “CP900001”. Further, a scan job and a print job related to advanced copying are represented by “SN900001” and “PR900001” using the same number as that for the advanced copy job. In this case, if the most significant digit of the number portion of a job ID is “9”, it is determined that the job is related to advanced copying, and scan/print jobs having IDs in which the remaining five-digit numbers match are related to an advanced copy job having an ID with the same five-digit number.

Referring back to FIG. 3, the advanced copy sequence will be described. If the start of advanced copying is instructed in step S309, the image forming apparatus 100 notifies the PC 117 selected by the user of that start of advanced copying in step S311. At this time, in step S312, the image forming apparatus 100 transmits, to the PC 117, a notification indicating the start of advanced copying and a job ID described above.

In step S313, the PC 117 that has received the start notification and the job ID starts an advanced copy application. Then, in response to the start notification, the PC 117 transmits, to the image forming apparatus 100, a scan start instruction and a job ID with which the job can be distinguished as being a scan job according to advanced copying, which are denoted by 315, thereby instructing the start of original reading. Further, in step S314, the advanced copy application registers the job ID received from the image forming apparatus 100 in an own job management list. Here, as described above, since the job is a scan job that is a part of the advanced copy function, a job ID such as “SNennnnn” with which the job can be distinguished as being a scan job according to advanced copying is transmitted as the job ID and registered. Moreover, the advanced copy application may have a configuration in which even after the completion of the advanced copy function, the job ID thereof, the job result, and the like can be kept as a history.

Accordingly, the image forming apparatus 100 receives, from the advanced copy application of the PC 117, an instruction to start original scanning and the ID of the scan job (that shows that the job is a scan job according to advanced copying), and registers that job in step S316. Then, the image forming apparatus 100 starts scanning the original in step S317. Note that the case of executing advanced copying of one original is illustrated in FIG. 3 to simplify the description.

Image data thus obtained by scanning the original is transmitted to the PC 117 in step S318. At this time, read image data as it is (RAW data) or image data denoted by 319 on which image processing has been performed by hardware resources of the image forming apparatus 100 is transferred to the PC 117.

In step S320, the PC 117 performs prescribed image processing on the image data received from the image forming apparatus 100, encodes the image data as necessary, and accumulates the image data in a storage apparatus (not shown) of the PC 117. At this time, if there are a plurality of originals, the PC 117 repeats the same processing on image data transferred in succession, and accumulates data on which image processing has been performed in the storage apparatus of the PC 117 until transfer of all image data ends. When transfer of all the scan image data ends, the image forming apparatus 100 enters a queue state in step S321 until an instruction for a print job is given from the PC 117.

Next, the advanced copy application performs processing for printing the processed image data accumulated in the storage apparatus of the PC 117 using the print driver installed in the PC 117. The print driver that has received a print instruction from the advanced copy application is started in step S323 by image data and a job ID being sent, which are denoted by 322. Then, a print job ID inheriting the integer portion of the job ID received from the advanced copy application is assigned in step S324, and that job is registered. Here, as described above, an ID such as “PRennnnn” is registered so as to show that the job is a print job related to advanced copying. Then, while accumulating (spooling) image data received from the advanced copy application in step S325, the print driver transmits the print job to the image forming apparatus 100 in step S326. Accordingly, the job ID and print data corresponding thereto, which are denoted by 327, are transmitted to the image forming apparatus 100 from the print driver.

Accordingly although the image forming apparatus 100 receives that job in the same way as a normal print job, the image forming apparatus 100 determines, using the job ID thereof, that the job is a job related to advanced copying that is already being executed, and registers the print job with such information in step S328. After that, in step S329, printing is started in accordance with the received print data. Then, when print processing normally ends in step S330, the advanced copy job is registered in step S331 as having ended normally in an advanced copy job history.

When the print driver completes transfer of print data normally, the print driver and the advanced copy application register the completion of that job (steps S332 and S333). Alternatively, in the case of the configuration in which a history is not kept, processing of erasing the job ID registered as a job that is being executed is performed.

As described above, according to the first embodiment, it is possible to distinguish a job related to advanced copying by changing a part of an ID to a specific letter while maintaining the format of a conventional copy job ID, a conventional scan job ID, and a conventional print job ID.

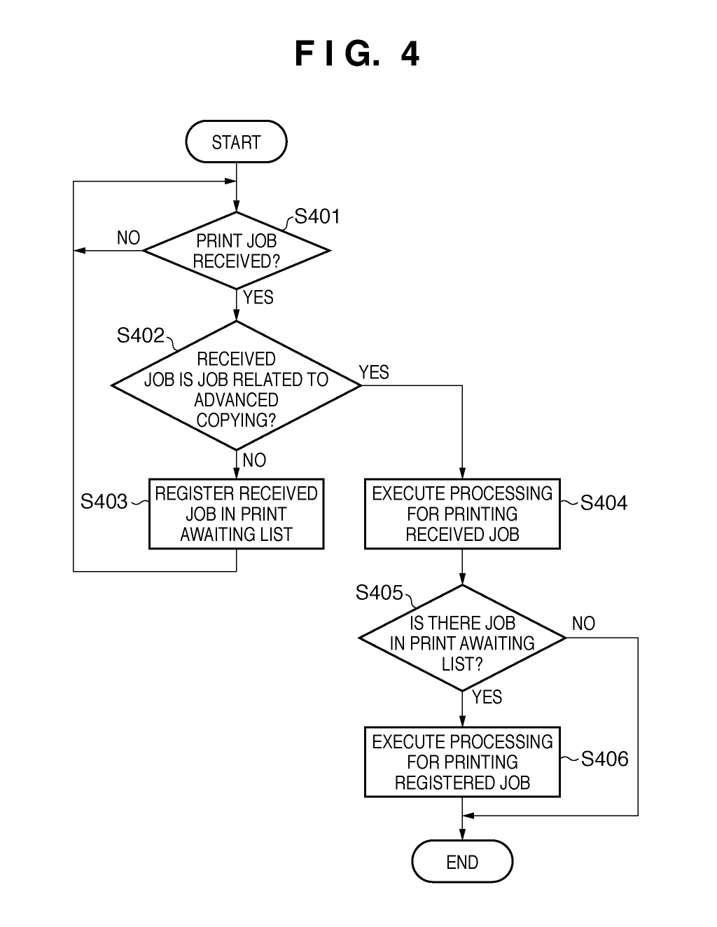

FIG. 4 is a flowchart describing the flow of processing in the advanced copy function of the image forming apparatus 100 according to the first embodiment. Steps S401 to S406 show processing steps, and correspond to the flow of job reception processing in the image forming apparatus 100 that is executing the advanced copy function shown in FIG. 3. Note that a control procedure corresponding to each step is stored in either the RAM 103, the ROM 104, or the hard disk drive (HDD) (not shown), and is executed under the control of the CPU 102.

In step S401, the CPU 102 is awaiting the reception of a print job from an external apparatus such as the PC 117 in the state where the CPU 102 is executing the advanced copy function, and has not received a print job related to the advanced copying yet. Upon receipt of a job in step S401, the processing proceeds to step S402, where the CPU 102 determines whether or not the job is a print job related to advanced copying that is being executed by checking the content of the job ID included in the job. In the first embodiment, if the job ID is, for example, “PR900001”, it is possible to determine that the job is a print job related to advanced copying as described above. On the other hand, if the job ID is, for example, “PR000001”, it is possible to determine that the job is a normal print job, which is not related to advanced copying. As a result of the determination in step S402, if it is determined that the job is a normal print job, the processing proceeds to step S403, where that job and the job ID thereof are registered in a print awaiting list (execution awaiting list). Here, printing is not immediately performed. Then, the processing returns to step S401 again, which is a step of awaiting job reception.

On the other hand, if it is determined in step S402 that the job is a print job related to advanced copying that is being executed, the processing proceeds to step S404, where print processing based on the print job related to advanced copying is immediately executed. Print processing performed here corresponds to the processing shown in the steps S328 to S331 in FIG. 3.

When print processing according to an advanced copy job is thus completed, the processing proceeds to step S405, where the CPU 102 determines whether or not a print job that awaits printing is registered in the print awaiting list. If it is determined here that a print job that awaits printing does not exist, the processing shown in this flowchart ends. On the other hand, if it is determined in step S405 that a print job that awaits printing exists, the processing proceeds to step S406, where printing of that print job registered in the print awaiting list is executed, and thereafter processing shown in the flowchart ends.

As described above, according to the first embodiment, the image forming apparatus 100 executes a print job related to advanced copying preferentially over a normal print job, and thus it is possible to prevent processing for printing another normal print job from interrupting while performing advanced copying. Consequently, it is possible to prevent advanced copy print processing from being delayed due to an interruption by another normal print job while the image forming apparatus is executing advanced copying.

### Second Embodiment

Next is a description of a second embodiment according to the present invention. Note that the hardware configuration of an image forming apparatus according to the second embodiment and the network configuration for connection to a PC are the same as those in the first embodiment described above, and thus a description thereof is omitted.

A configuration may be adopted in which in step S318 in the sequence of advanced copying shown in FIG. 3, the image forming apparatus 100 can immediately accept a next job (normal copying, advanced copying, scanning, printing, fax transmission, or the like) after the completion of transfer of a scan image to the PC 117. In this case, a case may occur in which while awaiting the reception of a print job related to precedent advanced copying (step S321), a succeeding print job related to advanced copying will be received prior thereto. Alternatively, a case may occur in which normal copying is executed while awaiting the reception of a print job related to advanced copying (step S321). An object of the present invention is to appropriately control the order of printing even in the above cases.

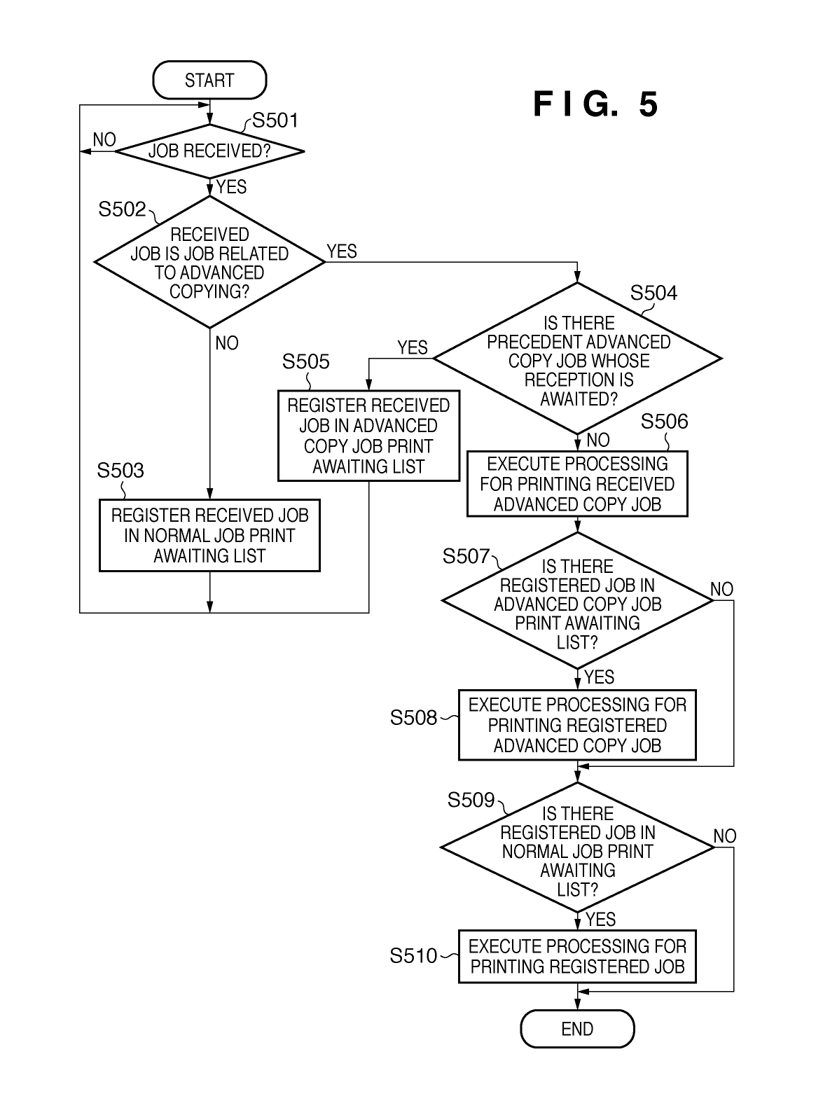

FIG. 5 is a flowchart describing control processing performed by the image forming apparatus 100 according to the second embodiment of the present invention. Steps S501 to S510 show processing steps, and correspond to the flow of control processing executed by the image forming apparatus 100 that is awaiting the reception of a print job related to advanced copying while executing the advanced copy function (step S321). Note that a control procedure corresponding to each step is stored in either the RAM 103, the ROM 104, or the hard disk drive (HDD) (not shown), and is executed under the control of the CPU 102.

In step S501, the CPU 102 is awaiting the reception of a job from an external apparatus such as the PC 117 while executing advanced copying and awaiting a print job thereof. Then, upon receipt of a job, the processing proceeds to step S502, the content of the job ID included in the job is checked, and it is determined whether or not the job is a print job related to advanced copying. In the second embodiment, if the job ID is, for example, “PR900001”, it can be determined that the job is a print job related to advanced copying. On the other hand, if the job ID is, for example, “PR000001”, it can be determined that the job is a normal print job that is not related to advanced copying. As a result of the determination in step S502, if it is determined that the job is a normal print job, the processing proceeds to step S503, where the job and the job ID thereof are registered in a normal job print awaiting list, and rather than executing printing at that point in time, the processing proceeds to step S501, where the CPU 102 awaits the reception of a job.

On the other hand, if it is determined in step S502 that the job is a print job related to advanced copying, the processing proceeds to step S504, where it is determined whether or not a print job related to precedent advanced copying whose reception is awaited exists among jobs received in S501. In the second embodiment, it is determined whether, among IDs of advanced copy jobs registered in step S310 in FIG. 3, a print job exists that is currently being executed and that has an ID with a smaller value than that of the ID of a print job received in step S501. For example, in the case where “CP900001” and “CP900002” are registered as advanced copy jobs that are being executed, if the job ID of a job received in step S501 is “PR900002”, it is determined that a precedent advanced copy job (“PR900001”) exists. Further, if the job ID of a job received in step S501 is “PR900001”, it is determined that a precedent advanced copy job does not exist.

If it is determined in step S504 that there is a preceding advanced copy job, the processing proceeds to step S505, where the received job and the job ID thereof are registered in an advanced copy job print awaiting list. Print processing is not performed at this point in time, and the processing again returns to step S501, where the reception of a next job is awaited. In this way, if it is determined that there is a preceding advanced copy job, execution of a succeeding print job is delayed until the printing start for the preceding advanced copy job is received. On the other hand, if it is determined in step S504 that there is no preceding advanced copy job, the processing proceeds to step S506, where processing for printing the print job is immediately executed. Print processing performed here corresponds to steps S328 to S331 shown in FIG. 3.

In this way, when printing of the advanced copy job is completed, the processing proceeds to step S507, where the CPU 102 next determines whether or not another job related to advanced copying that awaits printing is registered in the advanced copy print awaiting list. If it is determined here that a job that awaits printing exists, the processing proceeds to step S508, where printing of the advanced copy job that awaits printing is executed, and thereafter the processing proceeds to step S509. Print processing performed here corresponds to steps S328 to S331 shown in FIG. 3. If it is determined in step S507 that an advanced copy job that awaits printing does not exist, the processing proceeds to step S509. In step S509, it is determined whether or not a job that awaits printing is registered in the normal job print awaiting list. This flowchart immediately ends if it is determined that a job is not registered, whereas if a job is registered, the processing proceeds to step S510, where printing of the registered normal print job that awaits printing is executed. Then, this flowchart ends.

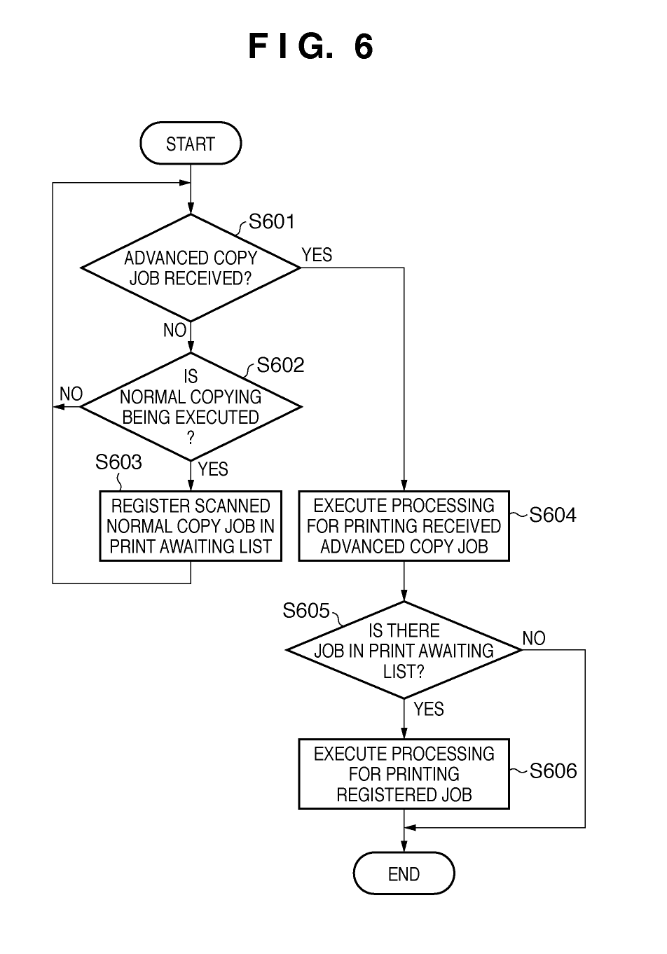

FIG. 6 is a flowchart describing processing performed by the image forming apparatus 100 according to the second embodiment when advanced copying and normal copying compete with each other. Steps S601 to S606 show processing steps, and correspond to the flow of printing order control processing shown in FIG. 3 and implemented by the image forming apparatus 100 that is awaiting the reception of a print job related to advanced copying while executing advanced copying (step S321). Note that the control procedure corresponding to each step is stored in either the RAM 103, the ROM 104, or the hard disk drive (HDD) (not shown), and is executed under the control of the CPU 102.

In step S601, the CPU 102 determines whether a job has been received while awaiting the reception of a print job related to advanced copying (step S321). If a job is not received, the processing proceeds to step S602, where it is determined whether or not normal copying is being executed. If normal copying is being implemented here before completion of advanced copying, the processing proceeds to step S603, where a scanned normal copy job is registered in the print awaiting list together with the ID of normal copying. Then, the processing proceeds to step S601, where the reception of a job is awaited again.

If a print job related to advanced copying that has been awaited is received in step S601, the processing proceeds to step S604, where processing for printing the print job related to advanced copying is executed. Print processing performed here corresponds to steps S328 to S331 that have already been described with reference to FIG. 3. Then, upon the completion of printing of this advanced copy job, the processing proceeds to step S605, where the CPU 102 determines whether or not a print job that awaits printing is registered in the print awaiting list. If such a job is not registered, processing in this flowchart immediately ends. On the other hand, if a print job that awaits printing is registered, the processing proceeds to step S606, where the registered print job is executed, and thereafter processing in this flowchart ends.

As described above, according to the second embodiment, the image forming apparatus 100 can prevent not only processing for printing another normal print job, but also processing for printing a succeeding advanced copy job and a normal copy job from interrupting while awaiting a print job related to advanced copying that is being executed.

### Third Embodiment

Next is a description of a third embodiment according to the present invention. Note that the hardware configuration of an image forming apparatus according to the third embodiment and the network configuration for connection to a PC are the same as those of the first embodiment described above, and thus a description thereof is omitted. In the first and second embodiments described above, until the end of printing of a job related to advanced copying executed first, processing for printing a normal copy job and an advanced copy job that are executed later and a normal print job received later is queued. This realizes print processing that does not confuse users by sequentially outputting prints in the order of generated requests.

However, in advanced copy processing, there are cases where a long time is necessary from the start of advanced copying until the completion thereof, such as a case where image processing performed by the PC 117 takes time, for example. Accordingly, if printing is always performed in the order of generated requests, a situation may occur in which a user of a succeeding job is kept waiting for a long time while the reception of a print job related to advanced copying is awaited. In view of this, the third embodiment describes control processing performed by the image forming apparatus 100 for solving such problems.

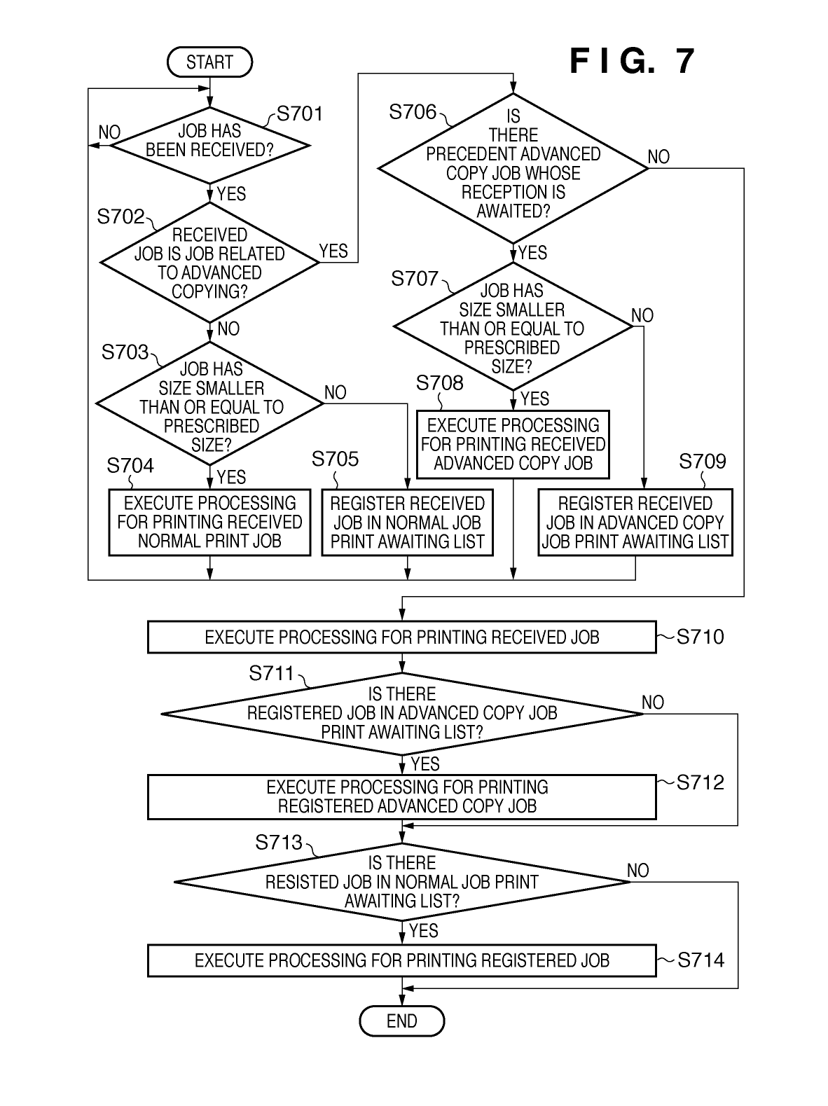

FIG. 7 is a flowchart describing control processing performed by the image forming apparatus 100 according to the third embodiment. Steps S701 to S714 show processing steps, and correspond to the flow of control processing implemented by the image forming apparatus 100 that is awaiting the reception of a print job related to advanced copying while executing advanced copying (step S321). Note that a control procedure corresponding to each step is stored in either the RAM 103, the ROM 104, or the hard disk drive (HDD) (not shown), and is executed under the control of the CPU 102.

In step S701, the CPU 102 is awaiting the reception of a job from an external apparatus such as the PC 117 in the state where the CPU 102 is executing advanced copying and has not received a print job thereof. Upon receipt of a job in step S701, the processing proceeds to step S702, where it is determined whether the job is a print job related to current advanced copying by checking the job ID included in the job. Note that this determination method is the same as that in 5402 in the first embodiment described above, and thus a description thereof is omitted. As a result of the determination in step S702, if it is determined that the job is a normal print job, the processing proceeds to step S703, where it is determined whether the size of the job is smaller than or equal to a prescribed threshold value. If it is determined here that the job has a size smaller than or equal to the prescribed size, the processing proceeds to step S704, where although advanced copy processing is being executed, rather than awaiting the start of printing thereof, processing for printing that normal job is immediately executed. Then, upon the completion of print processing, the processing returns to step S701 again, where the CPU 102 awaits the reception of a job. On the other hand, if it is determined in step S703 that the job has a size larger than the prescribed size, the processing proceeds to step S705, where that job and the job ID thereof are registered in the normal job print awaiting list, and printing is not executed at that point in time. Then, the processing proceeds to step S701, where the CPU 102 again awaits the reception of a job.

On the other hand, if it is determined, as a result of determination in step S702, that the job is a print job related to advanced copying, the processing proceeds to step S706, where it is determined whether a preceding advanced copy job in which the reception of a print job is awaited exists. The specific determination method in step S706 is the same as that in 5504 in the second embodiment, and thus a description thereof is omitted. If it is determined in step S706 that there is a preceding advanced copy job, the processing proceeds to step S707, where it is determined whether the size of the currently received job is smaller than or equal to the prescribed threshold value. If it is determined in step S707 that the job has a size smaller than or equal to the prescribed size, the processing proceeds to step S708, where although processing of advanced copying is being performed, and a print job thereof is being awaited, rather than awaiting the print start thereof, processing for printing the received job related to advanced copying is immediately executed. Then, upon the completion of print processing, the processing proceeds to step S701, where the CPU 102 awaits again the reception of a job. Further, if it is determined in step S707 that the currently received job is a job related to advanced copying having a size larger than the prescribed size, the processing proceeds to step S709, where the received job related to advanced copying and the job ID thereof are registered in the advanced copy job print awaiting list. Then, print processing is not performed at that point in time, and the processing proceeds to step S701, where the CPU 102 awaits again the reception of a job.

If it is determined in step S706 that there is no preceding advanced copy job, the processing proceeds to step S710, where processing for printing the currently received job related to advanced copying is immediately executed. Processing in steps S711 to S714 is the same as the processing in steps S506 to S510 in FIG. 5 described above, and thus a description thereof is omitted.

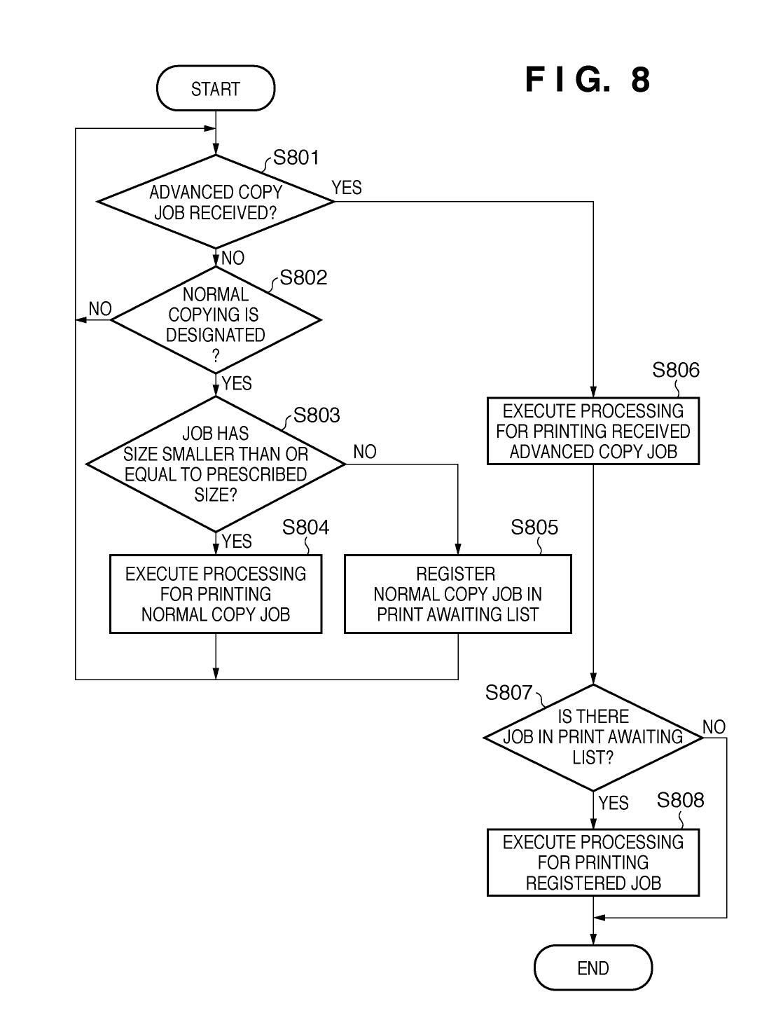

FIG. 8 is a flowchart describing control processing performed by the image forming apparatus 100 according to the third embodiment. Steps S801 to S808 show processing steps, and correspond to the flow of control processing implemented by the image forming apparatus 100 that is awaiting the reception of a print job related to advanced copying while executing the advanced copy function (step S321). Note that the control procedure corresponding to each step is stored in either the RAM 103, the ROM 104, or the hard disk drive (HDD) (not shown), and is executed under the control of the CPU 102.

In step S801, the CPU 102 determines whether a job has been received while awaiting the reception of a print job related to advanced copying (step S321). If a job is not received, the processing proceeds to step S802, where it is determined whether a normal copy job is designated. If the normal copy job is not designated either, the processing again proceeds to step S801, where the reception of a job is awaited. If it is determined in step S802 that the normal copy job is designated before advanced copy printing, the processing proceeds to step S803, where it is determined whether the size of the normal copy job is smaller than or equal to a prescribed threshold value. If it is determined here that the normal copy job has a size smaller than or equal to the prescribed size, the processing proceeds to step S804, where although reception of a print job related to advanced copying is being awaited, rather than awaiting the printing start thereof, processing for printing the normal copy job is immediately executed. Then, upon the completion of processing for printing the normal copy job, the processing proceeds to step S801, where the CPU 102 again awaits the reception of a job. Further, in step S803, if it is determined that the normal copy job has a size larger than the prescribed size, the processing proceeds to step S805, where the normal copy job is registered in the print awaiting list together with the ID of normal copying, and the processing proceeds to step S801.

If a print job related to advanced copying that has been awaited is received in step S801, the processing proceeds to step S806, where processing for printing that advanced copy job is executed. Note that processing in steps S806 to S808 is the same as that in steps S604 to S606 in FIG. 6, and thus a description thereof is omitted.

As described above, according to the third embodiment, if the image forming apparatus 100 receives a job that satisfies a prescribed condition while executing advanced copying, but before printing thereof, the later-received job (normal print job, succeeding advanced copy job, normal copy job) can be executed before that preceding advanced copying.

Note that although the third embodiment has been described using the size of a job as an example of a condition for determining whether a job is to be immediately executed, the present invention is not necessarily limited to the size of a job. For example, in addition thereto, various reference values such as the number of sheets to be printed and a printing time period can be used as a determination condition. Further, a configuration may be adopted in which a determination condition and a threshold value therefor can be dynamically changed, and a determination condition and a threshold value that differ for each job (normal print job, succeeding advanced copy job, normal copy job) can be set. Further, a criterion of determination is whether a time period necessary for job execution is within a prescribed time period, including a job size, the number of sheets to be printed, a printing time period, and the like.

### Fourth Embodiment

Next is a description of a fourth embodiment of the present invention. Note that the hardware configuration of an image forming apparatus according to the fourth embodiment and the network configuration for connection to a PC are the same as those in the first embodiment described above, and thus a description thereof is omitted.

In the third embodiment described above, a reference value such as a job size, the number of sheets to be printed, or a printing time period is used as a determination condition, and printing of another job (normal print job, succeeding advanced copy job, normal copy job) is executable if a prescribed condition is satisfied. However, users are not notified whether printing of another job is executable, and thus it is not easy for the user who is executing advanced copying and a user who desires to execute the other job to know this. For this reason, it is difficult for the users of respective jobs to determine whether a print is his/her print, and thus a situation in which he/she takes another user's print may occur. In view of this, the fourth embodiment describes control processing performed by the image forming apparatus 100 for solving the above problems.

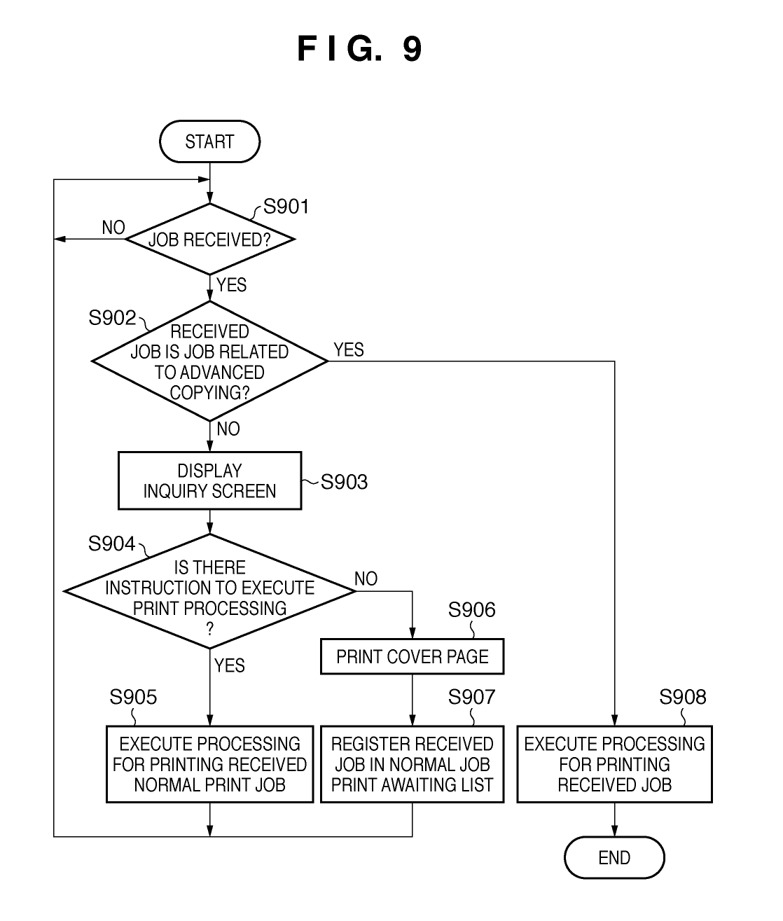

FIG. 9 is a flowchart describing control processing performed by the image forming apparatus 100 according to the fourth embodiment. Steps S901 to S907 show processing steps, and correspond to the flow of processing implemented by the image forming apparatus 100 that is awaiting the reception of a print job related to advanced copying while executing the advanced copy function (step S321). Note that a control procedure corresponding to each step is stored in either the RAM 103, the ROM 104, or the hard disk drive (HDD) (not shown), and is executed under the control of the CPU 102.

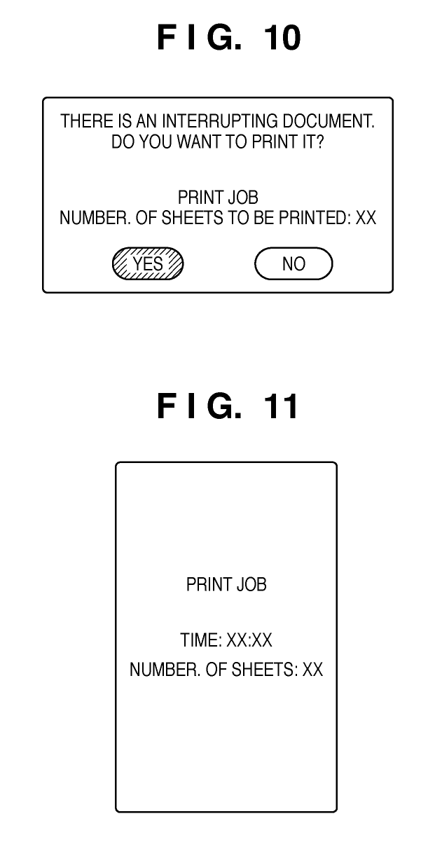

In step S901, the CPU 102 is executing advanced copying shown in FIG. 3, and is awaiting the reception of a print job from an external apparatus such as the PC 117. Upon receipt of a job, the processing proceeds to step S902, where it is determined whether the received job is a print job related to advanced copying by checking the job ID included in the job. Note that the specific method of this determination is the same as that in 5402 in the first embodiment described above, and thus a description thereof is omitted. If it is determined in step S902 that the received job is a normal print job, the processing proceeds to step S903, where a screen shown in FIG. 10 is displayed on the display unit 205.

FIG. 10 is a diagram showing an example of a user inquiry screen according to the fourth embodiment.

Here, this screen is displayed when an interrupting print job from another PC is received, while executing advanced copying. In FIG. 10, the number of pages (number of sheets) of document data to be printed in the interrupting printing, and “yes” and “no” buttons for instructing whether to accept the interrupting printing are displayed.

Then, if an instruction for not executing print processing is received (“no” has been instructed) from the user in step S904, the processing proceeds to step S906, where a cover page shown in FIG. 11 is printed.

FIG. 11 is a diagram showing an example of a printed cover page according to the fourth embodiment.

Here, the time at which an interrupting document in FIG. 10 was deferred rather than being printed, and the number of sheets thereof (corresponding to the number of sheets in FIG. 10) are printed. Then, the processing proceeds to step S907, where the received normal print job and the job ID thereof are registered in the normal job print awaiting list. Then, the processing proceeds to step S901, where the CPU 102 awaits the reception of a next job.

On the other hand, if printing of an interrupting document is instructed (“Yes” has been instructed) in step S904, the processing proceeds to step S905, where although advanced copy processing is being executed, rather than awaiting printing thereof, job control processing for immediately printing the received interrupting document is executed. When print processing is completed in this way, the processing again proceeds to step S901, where the CPU 102 awaits the reception of a next job. Further, if it is determined in step S902 that the job is a print job related to advanced copying, the processing proceeds to step S908, where the received print job related to advanced copying is executed.

As described above, according to the fourth embodiment, the user can select whether to print another job (normal print job, succeeding advanced copy job, normal copy job) that the image forming apparatus 100 has received while executing advanced copying and awaiting a print job thereof, before that advanced copying. This can suppress situations in which another user's print is taken.

Note that although the fourth embodiment has been described using the number of sheets to be printed and the printing time as examples of content displayed on the display unit 205 and the content printed on a cover page, the present invention is not necessarily limited to the number of sheets to be printed or the printing time. In addition thereto, various information such as an ID of a PC can be the content displayed or printed.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-128275, filed Jun. 3, 2010, which is hereby incorporated by reference herein in its entirety.

What is claimed is:

1. An image forming apparatus capable of executing a specified copy job in which copy processing is performed cooperatively with an external apparatus, the image forming apparatus comprising:
an acceptance unit that accepts an instruction to execute the specified copy job;
a reading unit that generates image data by reading an original;
a transmission unit that transmits the image data generated by the reading unit to the external apparatus if the acceptance unit has accepted the instruction to execute the specified copy job;
a reception unit that receives, from the external apparatus, processed image data obtained by the external apparatus performing processing on the image data transmitted by the transmission unit;
a print unit that prints an image on a recording material based on the processed image data that has been received by the reception unit; and
a restriction unit that restricts printing of other image data that has been received between when the transmission unit transmits the image data to the external apparatus and when the reception unit receives the processed image data.

2. The image forming apparatus according to claim 1,
wherein the restriction unit registers the other image data as a processing awaiting job.

3. The image forming apparatus according to claim 1, further comprising:
a determination unit that determines whether image data received after the transmission unit has transmitted the image data to the external apparatus is the processed image data,
wherein the restriction unit restricts printing of the received image data if the received image data is not the processed image data.

4. The image forming apparatus according to claim 1, further comprising:
a notification unit that notifies a start of the specified copy job to the external apparatus in response to the instruction to execute the specified copy job being accepted by the acceptance unit,
wherein the reading unit starts reading of the original in response to a reading start instruction being transmitted from the external apparatus according to the notification by the notification unit.

5. The image forming apparatus according to claim 4, further comprising:
an issuance unit that issues an identifier that indicates the specified copy job in response to the instruction to execute the specified copy job being accepted by the acceptance unit,
wherein the notification unit notifies the external apparatus of the identifier issued by the issuance unit.

6. The image forming apparatus according to claim 5,
wherein the reception unit receives, from the external apparatus, the identifier of which the external apparatus has been notified by the notification unit, together with the processed image data.

7. The image forming apparatus according to claim 6, further comprising:
a determination unit that determines whether image data received after the transmission unit has transmitted the image data to the external apparatus is the processed image data, based on an identifier transmitted together with the received image data,
wherein the restriction unit restricts printing of the received image data if the received image data is not the processed image data.

8. A control method of controlling an image forming apparatus capable of executing a specified copy job in which copy processing is performed cooperatively with an external apparatus, the method comprising:
an acceptance step of accepting an instruction to execute the specified copy job;
a reading step of generating image data by reading an original;
a transmission step of transmitting the image data generated in the reading step to the external apparatus if the instruction to execute the specified copy job has been accepted in the acceptance step;
a reception step of receiving, from the external apparatus, processed image data obtained by the external apparatus performing processing on the image data transmitted in the transmission step;
a print step of printing an image on a recording material based on the processed image data that has been received in the reception step; and
a restriction step of restricting printing of other image data that has been received between when the image data is transmitted to the external apparatus in the transmission step and when the processed image data is received in the reception step.
